(19) United States
(12) Patent Application Publication
(10) Pub. No.: US 2003/0236694 A1
(43) Pub. Date: Dec. 25, 2003

(54) System and method for generating sales reports using a mobile terminal

(76) Inventors: Fu-Yu Liu, Taipei (TW); Yi-Nan Li, Taipei (TW)

Correspondence Address: WEI TE CHUNG, FOXCONN INTERNATIONAL, INC., 1650 MEMOREX DRIVE, SANTA CLARA, CA, 95050, US

(21) Appl. No.: 10/328,814

(22) Filed: Dec. 23, 2002

(30) Foreign Application Priority Data
Jun. 20, 2002 (TW) 091113538

(51) Int. Cl. G06F 17/60

(52) U.S. Cl. 705/9

(57) ABSTRACT

A system for generating sales reports using a mobile terminal includes a database server (101), a mobile commerce server (103) electronically linked with the database server for generating business schedules, and a plurality of mobile terminals (109) linked with the mobile commerce server for assisting execution of commercial activities in accordance with business schedules (208) downloaded from the mobile commerce server. Each mobile terminal includes a business schedule storing module (301) for storing downloaded business schedules and for assisting arrangement of business visits, and a data analyzing module (305) for processing data and generating sales reports. The mobile commerce server comprises an application processing module (106) for generating business schedules and updating data. A related method includes: (a) displaying information on commercial promotion activities; (b) processing merchandise distribution data, and generating a merchandise distribution analysis report; and (c) compiling merchandise sales data, and generating a market share analysis report.

### BACKGROUND OF THE INVENTION

1. Field of the Invention

The present invention relates to a system and method for generating sales reports, and more particularly to a system and method for generating sales reports and displaying the sales reports in execution of mobile commerce. This application relates to two other applications having the same inventors and the same assignee with the invention, of which one has a title of “SYSTEM AND METHOD FOR REVIEWING DATA IN A MOBILE TERMINAL” and the other has a title of “SYSTEM AND METHOD FOR ASSISTING EXECUTING OF MIBILE COMMERCE”.

2. Description of Related Art

Traditional communication means such as letters, telephones, and faxes are used in a typical conventional business model. In such model, many people waste time on data collection and information transfer. Human error leads to serious mistakes being made, which can cause huge damage to an enterprise. There are also other difficulties including providing adequate technical support, high costs, and low customer satisfaction when mistakes occur.

Since the advent of wireless enterprise applications, new business models have appeared on the market. These business models alter the nature of a company's interactions with outside entities. Today, companies around the globe are realizing the benefits of using small wireless hand-held mobile devices, which have emerged as an ideal mobile sales assistant. With the ability of such mobile devices to access a company's data system and the advantages of portability and low cost of ownership, mobile electronic commerce is becoming increasingly popular and promises to further change traditional business models. Typically, mobile electronic commerce is conducted using a personal computer connected to the Internet via an Internet service provider. A wide variety of different commercial opportunities are thus made possible.

For example, U.S. Pat. No. 5,710,887 entitled Computer System and Method for Electronic Commerce discloses a business method to promote merchandise via the Internet. Firstly, an enterprise presents product promotion information on its website for customers to access. If a customer visits the website and chooses to view detailed information on a product, the enterprise's host computer promptly uploads the product's price and other detailed data to the customer's computer terminal for viewing. Accordingly, the customer can select a desired product and place orders on line. However, the commercial transaction takes place without any interactive communication between the customer and the enterprise. The customer cannot obtain further information on the product, and the enterprise cannot obtain detailed information on customers' product demands and related needs.

In view of the above, a system and method for execution of mobile commerce is desired; in particular, a system and method that ensures that data on clients is up-to-date so that accurate reports on sales to clients can be generated.

### SUMMARY OF THE INVENTION

Accordingly, an objective of the present invention is to provide a system for generating sales reports automatically by using a mobile terminal in execution of mobile commerce.

Another objective of the present invention is to provide a method for generating sales reports using a mobile terminal in execution of mobile commerce to assist a sales representative in making decisions on sales orders.

In order to achieve the first above-mentioned objective, a system for generating sales reports automatically in accordance with a preferred embodiment of the present invention comprises a database server, a mobile commerce server linked with the database server for generating business schedules, and a plurality of mobile terminals linked with the mobile commerce server for assisting execution of commercial activities in accordance with business schedules downloaded from the mobile commerce server. Each mobile terminal comprises a business schedule storing module for storing downloaded business schedules and for assisting arrangement of business visits, and a data analyzing module for processing data and generating sales reports. The mobile commerce server comprises an application processing module for generating business schedules in accordance with data stored in the database server, and for updating data stored in the database server in accordance with data sent from the mobile terminals.

In order to achieve the second above-mentioned objective, a method for generating sales reports automatically in accordance with the present invention comprises the steps of: (a) displaying information on commercial promotion activities; (b) processing merchandise distribution data, and generating a merchandise distribution analysis report; and (c) compiling merchandise sales data, and generating a market share analysis report.

Other objects, advantages and novel features of the present invention will be drawn from the following detailed description of preferred embodiments of the present invention with the attached drawings, in which:

### BRIEF DESCRIPTION OF THE DRAWINGS

FIG. 1 is a schematic diagram of a system for generating sales reports using a mobile terminal in accordance with a preferred embodiment of the present invention, the system comprising a database server, a mobile commerce server and at least one mobile terminal;

FIG. 2 is a schematic diagram of detailed structure of the database server of FIG. 1, and shows data communication between the database server, the mobile commerce server and one mobile terminal of the system of FIG. 1;

FIG. 3 is a schematic block diagram illustrating function modules of the mobile terminal of FIG. 1;

FIG. 4 is a flowchart of executing commercial activities in accordance with a preferred embodiment of the present invention;

FIG. 5 is a flowchart of details of one step of FIG. 4, namely assisting execution of commercial activities;

FIG. 6 is a flowchart of generating sales reports in accordance with the preferred embodiment of the present invention;

FIG. 7 is a flowchart of details of one step of FIG. 6, namely displaying commercial promotion activities for a client;

FIG. 8 is a flowchart of details of another step of FIG. 6, namely generating and displaying a merchandise distribution analysis report; and

FIG. 9 is a flowchart of details of still another step of FIG. 6, namely generating and displaying a merchandise market share analysis report.

### DETAILED DESCRIPTION OF PREFERRED EMBODIMENTS OF THE INVENTION

Reference will now be made to the drawings to describe the present invention in detail.

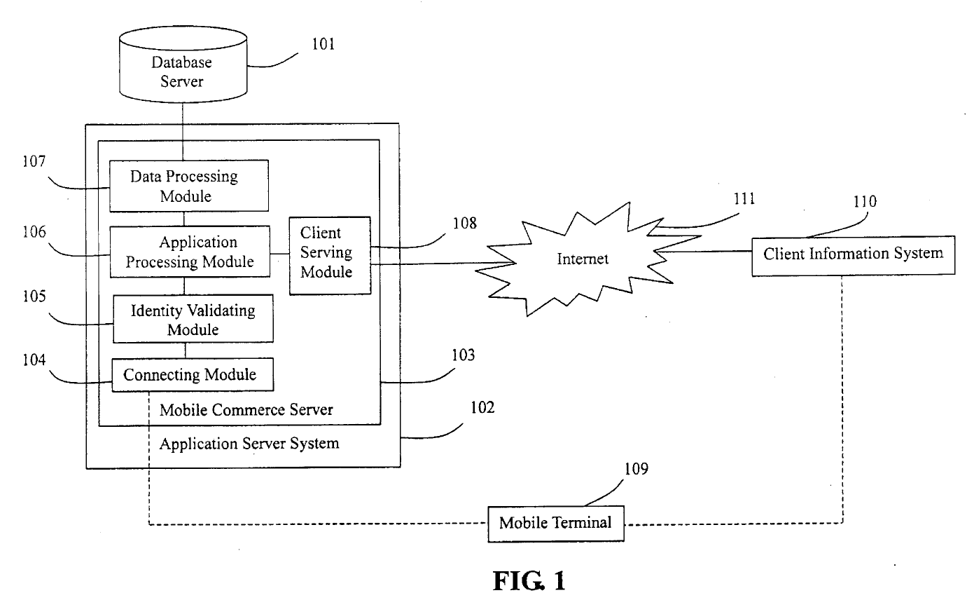

FIG. 1 is a schematic diagram of a system for generating sales reports in execution of mobile commerce in accordance with a preferred embodiment of the present invention. The system for generating sales reports comprises a three-tier information system. The three-tier information system comprises a database server 101 (the bottom tier), an application server system 102 (the middle tier), and a plurality of distributed terminal workstations 109 (the top tier, only one shown). The application server system 102 of the preferred embodiment comprises a mobile commerce server 103. Each terminal workstation 109 of the preferred embodiment is a mobile terminal 109, which can be a Personal Digital Assistant (PDA), a pocket personal computer (PC), a laptop computer, a palmtop computer, a smart phone or a notebook computer. A client information system 110 is connected with each mobile terminal 109 via a cable, infrared signals, or wireless communications. Each mobile terminal 109 connects with the mobile commerce server 103 via a cable, infrared signals, or wireless communications. The mobile commerce server 103 connects with the database server 101, and is used for generating business schedules in accordance with data stored in the database server 101. The mobile terminal 109 downloads a business schedule from the mobile commerce server 103, for assisting execution of commercial activities. The mobile terminal 109 shows steps of required commercial activities in accordance with the business schedule, records data on execution of commercial activities, and uploads data on transactions and on execution of commercial activities for updating of data stored in the client information system 110.

The mobile commerce server 103 comprises a connecting module 104, an identity validating module 105, an application processing module 106, a data processing module 107, and a client serving module 108. The connecting module 104 connects with the mobile terminal 109, and is used for transferring data between the mobile terminal 109 and the mobile commerce server 103. The identity validating module 105 checks identities of personnel such as sales representatives, and distributes various business schedules to various sales representatives. The application processing module 106 creates business schedules for every sales representative in accordance with data stored in the database server 101, and updates data stored in the database server 101 in accordance with data sent from the mobile terminals 109. The data processing module 107 connects with the database server 101, and transfers data between the database server 101 and the mobile commerce server 103. The client serving module 108 connects with the client information system 110 via the Internet 111. The client serving module 108 sends information on mobile commerce to clients, and receives data on cooperating with clients and data on requirements of clients.

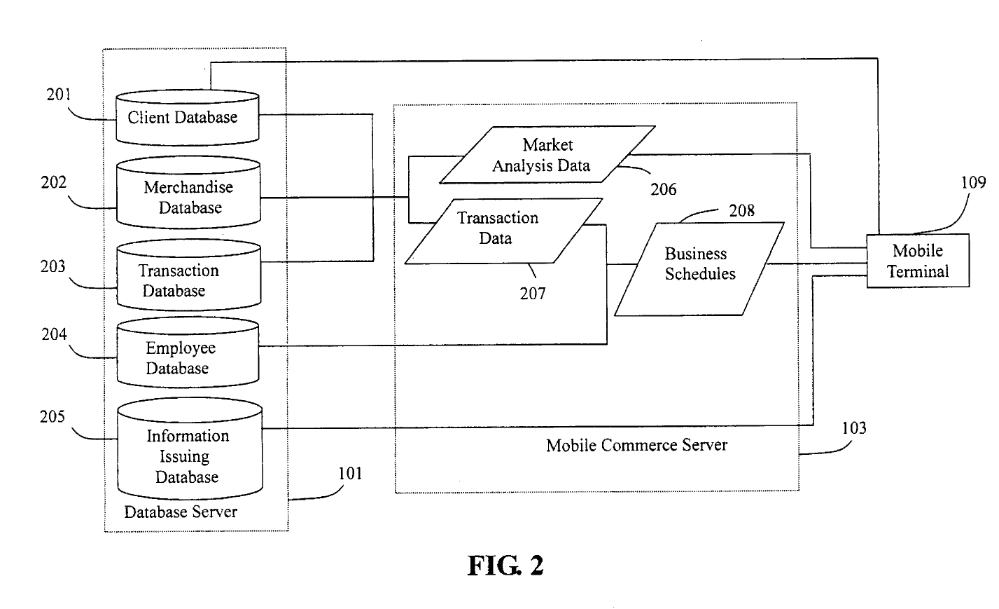

FIG. 2 is a schematic diagram of detailed infrastructure of the database server 101, and shows data communication between the database server 101, the mobile commerce server 103 and one mobile terminal 109. The database server 101 is a central database of an entire enterprise. The database server 101 comprises: a client database 201 for storing data on clients; a merchandise database 202 for storing data on merchandise sold by the enterprise; a transaction database 203 for storing transaction data on the enterprise; an employee database 204 for storing employee data including data on all sales representatives; and an information issuing database 205 for storing information issued by the enterprise. The application processing module 106 of the mobile commerce server 103 integrates data stored in the client database 201, data stored in the merchandise database 202, and data stored in the transaction database 203 to create transaction data 207 and market analysis data 206. The transaction data 207 and the market analysis data 206 are stored in the mobile commerce server 103. The transaction data 207 and data stored in the employee database 204 are processed by the application processing module 106 to create business schedules 208 for sales representatives. The business schedules 208 are stored in the mobile commerce server 103. During the process of downloading data from the mobile commerce server 103, the business schedules 208, market analysis data 206, data stored in the client database 201, and data stored in the information issuing database 205 are transferred to the mobile terminal 109 via the connecting module 104 of the mobile commerce server 103.

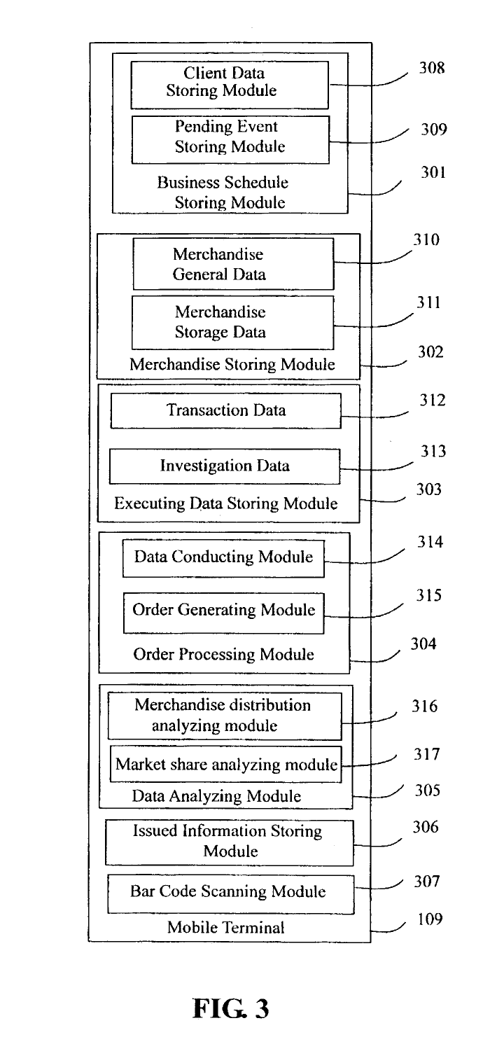

FIG. 3 is a schematic block diagram of function modules of one mobile terminal 109. The mobile terminal 109 comprises: a business schedule storing module 301 which is used to record work flow and clients that a sales representative visits; a merchandise storing module 302 which is used to store all merchandise information on the enterprise as a reference for the sales representative to inquire of; an executing data storing module 303 which is used to record data on execution of commercial activities; an issued information storing module 306 which is used to store information on the enterprise's current news, merchandise shortage notes, and newly promoted products; a bar code scanning module 307 which is used to scan and identify various clients' bar codes which respectively represent various clients; an order processing module 304 which is used to process data and generate orders; and a data analyzing module 305 which is used to process data and generate analysis reports.

The business schedule storing module 301 comprises a client data storing module 308, and a pending event storing module 309. The client data storing module 308 stores commercial activities information on clients, including: client basic data such as name, address and phone number; client ordering data; and accounts receivable. The pending event storing module 309 is used to remind the sales representative of matters that need to be attended to. For instance, such matters may be orders that need conducting, collection of accounts receivable, and market investigation. The merchandise storing module 302 comprises merchandise general data 310 and merchandise storage data 311. The merchandise general data 310 includes basic merchandise data such as name, serial number and specification, merchandise price data and key merchandise data. The merchandise storage data 311 includes corresponding merchandise inventory volume and distribution information. The executing data storing module 303 stores transaction data 312 and investigation data 313. The information in the executing data storing module 303 is sent to the mobile commerce server 103, and is processed by the application processing module 106. The information in the database server 101 is updated accordingly. The order processing module 304 comprises a data conducting module 314 and an order generating module 315. The data conducting module 312 is used for processing merchandise data downloaded from the database server 101 and from the client information system 110. The order generating module 313 is used to generate computer advice orders, sales representative advice orders and formal sales orders in accordance with the data processed by the data conducting module 314. The data analyzing module 305 comprises a merchandise distribution analyzing module 316 and a market share analyzing module 317. The merchandise distribution analyzing module 316 is used to analyze merchandise distribution data. The market share analyzing module 317 is used to process market share data and generate market share analysis reports. Subsequently, all data on orders is uploaded to the database server 101 for storing.

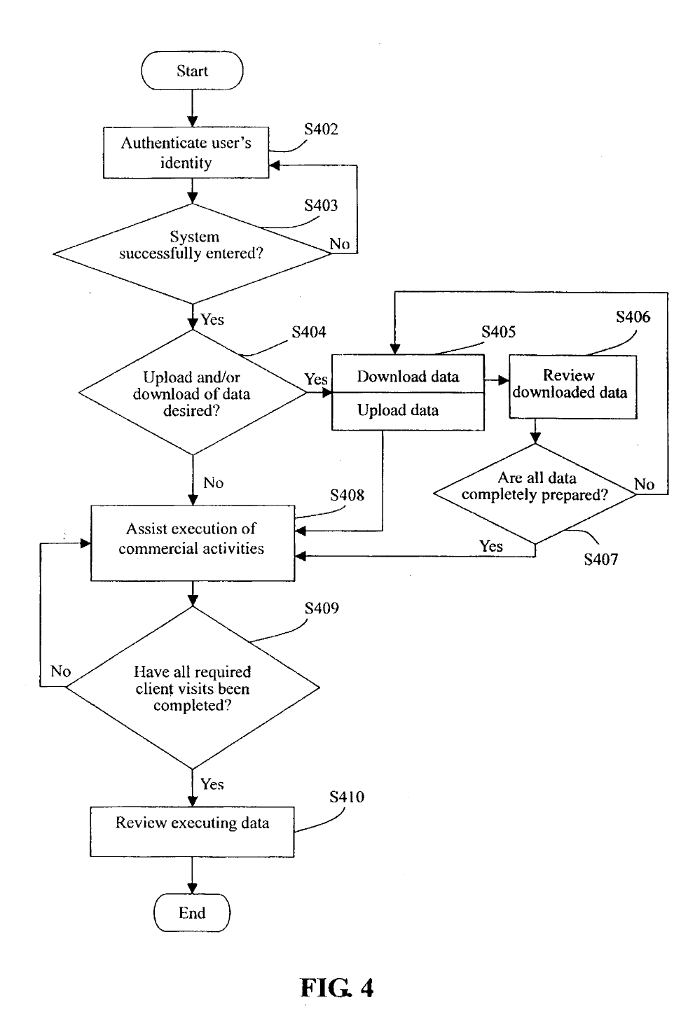

FIG. 4 is a flowchart of executing mobile commerce in accordance with a preferred embodiment of the present invention. Firstly, in step S402, before a user enters the system, the mobile terminal 109 authorizes access for the user. In step S403, if the user cannot successfully enter the system, then the procedure returns to step S402. If and when the user successfully enters the system, then in step S404, the mobile terminal 109 inquires whether or not the user wants to upload and/or download data. If the user does not want to upload or download data, then the procedure proceeds directly to step S408 described below. Otherwise, in step S405, the mobile terminal 109 downloads data including a business schedule from the mobile commerce server 103, and/or uploads data on execution of commercial activities already completed to the executing data storing module 303 of the mobile commerce server 103. These download and upload operations can be performed individually and separately. If the mobile terminal 109 only uploads data, then the procedure proceeds directly to step S408 described below. If the mobile terminal 109 downloads data, then in step S406, when all the data have been downloaded, the mobile terminal 109 displays both data wanted by the user for executing commercial activities and the downloaded data. The user compares the wanted data with the downloaded data, and marks any outstanding wanted data. Then, in step S407, the business schedule storing module 301 determines whether the downloaded data are complete having regard to the user's mark, if any. If the downloaded data are not complete, then the procedure returns to step S405, and the outstanding wanted data are downloaded. If the downloaded data are complete, then the procedure proceeds to step S408. In step S408, the actual commercial activities are performed, and the executing data storing module 303 records corresponding operations during the process of execution of the commercial activities. When the commercial activities are finished, in step S409 the business schedule storing module 301 determines whether all required visits to clients have been completed. If all required client visits have not been completed, then the procedure returns to step S408 and the sales representative continues to visit other clients. If and when all required client visits have been completed, then in step S410, the executing data storing module 303 collects and analyzes all client visit information on the business schedule, and generates a consolidated report for the sales representative to review.

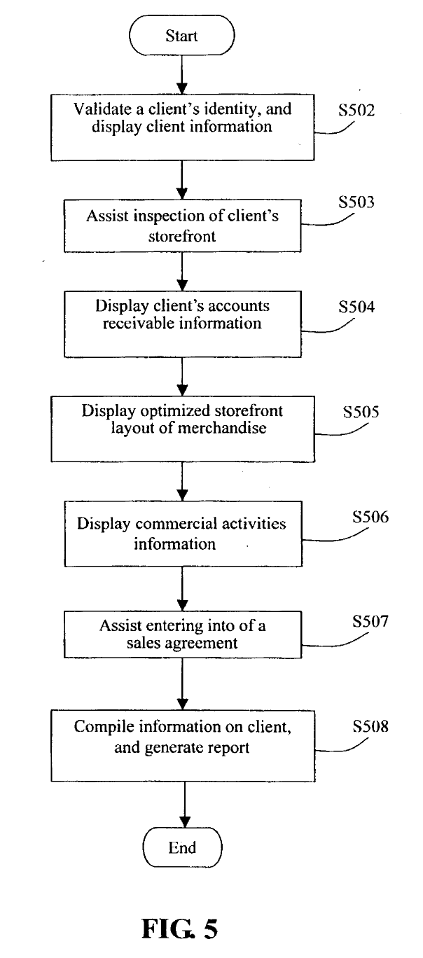

FIG. 5 is a flowchart of details of step S408 of FIG. 4, namely assisting execution of commercial activities. Firstly, in step S502 the mobile terminal 109 validates a client's identity, and displays corresponding client information. The client's identity can be validated by either scanning the client's bar code, or manually entering the client's name, code or other details. The client information includes basic information on the client.

In step S503, the mobile terminal 109 assists the user in inspecting the client's storefront premises. Matters examined may include verification of the enterprise's merchandise inventory, checking of the client's merchandise information, investigation of merchandise prices, investigation of fake products, and compiling of questionnaires. The executing data storing module 303 records the client visit and noteworthy matters arising from the visit. All this information is transferred to the mobile commerce server 103, so that the next business schedule can be arranged. In step S504, the business schedule storing module 301 displays the client's accounts receivable information, and reminds the sales representative to collect any outstanding payments. The application processing module 106 of the mobile server 103 computes a new optimized storefront layout of merchandise based on the enterprise's sales strategy, the client's current storefront layout, the client's previous storefront layouts, and previous storefront layouts of other clients. In step S505, the new optimized storefront layout is stored in the business schedule storing module 301, and is shown on the mobile terminal 109. The new optimized storefront layout is used to guide the client to adjust its storefront layout of merchandise at its storefront premises. In step S506, the business schedule storing module 301 shows the enterprise's scheduled commercial activities on the mobile terminal 109. Such scheduled activities are used to assist the client to formulate its own sales strategy.

In step S507, the mobile terminal 109 assists the sales representative to enter into a sales agreement with the client. Firstly, the executing data storing module 303 automatically creates a sales order in accordance with verified merchandise inventory information and a merchandise sales record of the client. The sales representative modifies the order in light of consultations with the client. When a final order is created, the mobile terminal 109 displays a notice advising whether the total price of the order is within the client's credit allowance. If the client wants to return merchandise, the executing data storing module 303 records data on returned merchandise.

Finally, in step S508 the executing data storing module 303 compiles information on the client, and generates a report on the client for the sales representative to check. All such information and the report are sent to the mobile commerce server 103, and processed by the application processing module 106. Subsequently, the processed information is transferred to the database server 101, and the application processing module 106 updates all data stored in corresponding databases.

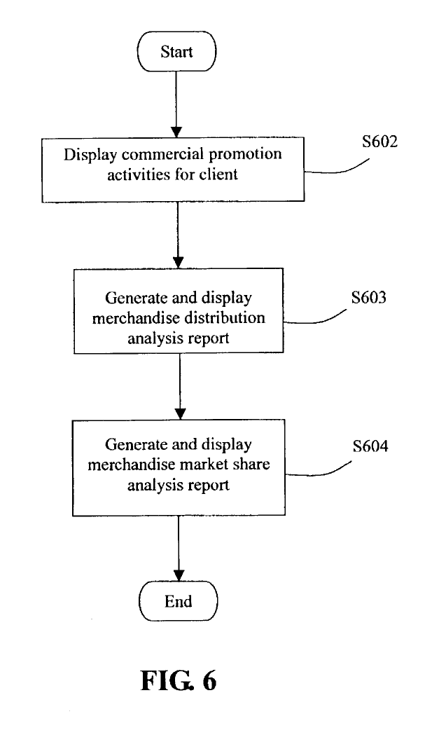

FIG. 6 is a flow chart of generating sales reports in accordance with the preferred embodiment of the present invention. Firstly, in step S602, the mobile terminal 109 searches for suitable commercial promotion activities for the client in the issued information storing module 306, and displays the activities in picture form. The commercial activities are stored in the form of still picture files and motion picture files. In step S603, the mobile terminal 109 processes data including the sales representative advice order data, formal order data downloaded from the database server 101, and current verified merchandise data obtained during verifying of merchandise. The mobile terminal 109 generates a merchandise distribution analysis report, and displays the merchandise distribution analysis report in picture form. In step S604, the mobile terminal 109 downloads merchandise sales data from the client information system 110, generates a merchandise market share analysis report, and displays the merchandise market share analysis report.

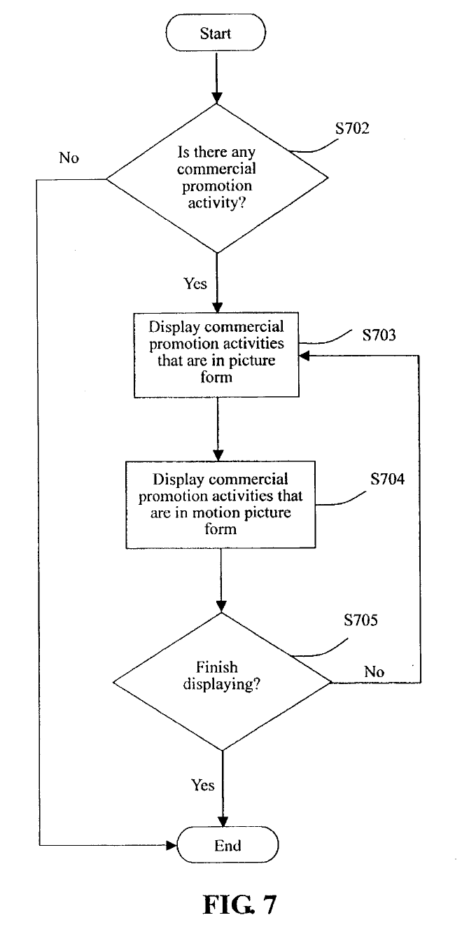

FIG. 7 is a flowchart of details of step S602 of FIG. 6, namely displaying commercial promotion activities for the client. Firstly, in step S702, the mobile terminal 109 searches in the issued information storing module 306 to find whether there are any commercial promotion activities for the client. If there are no commercial promotion activities for the client, then the procedure is ended. If there are commercial promotion activities for the client, then in step S703 the mobile terminal 109 displays the commercial promotion activities whose content is in picture form. Then in step S704, the mobile terminal 109 displays commercial promotion activities whose content is in the form of motion pictures. In step S705, the sales representative determines whether the display of commercial activities has finished. If the display has not finished, then the procedure returns to step S703. If and when the display has finished, then the procedure is ended.

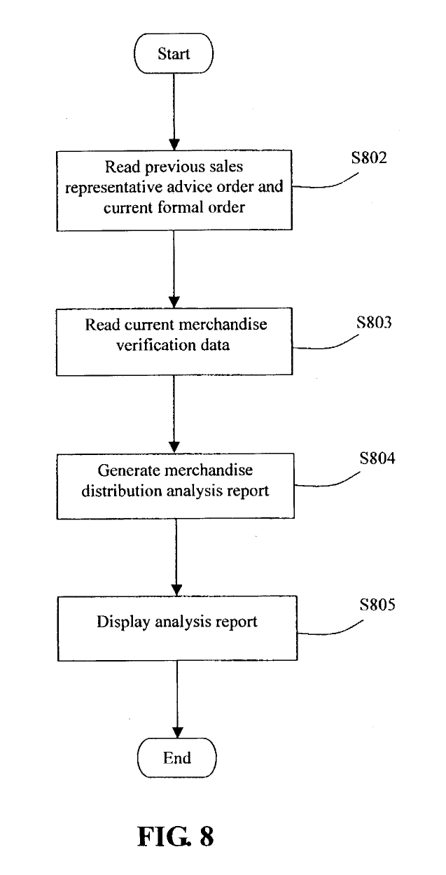

FIG. 8 is a flowchart of details of step S603 of FIG. 6, namely generating and displaying a merchandise distribution analysis report. Firstly, in step S802, the mobile terminal 109 reads data on a corresponding previous sales representative advice order and on a current formal order in the executing data storing module 303. Then, in step S803, the mobile terminal 109 reads current verified merchandise data. In step S804, the mobile terminal 109 compiles and analyzes all collected data to generate the merchandise distribution analysis report. Finally, in step S805, the mobile terminal 109 displays the merchandise distribution analysis report in picture form. The merchandise distribution analysis report includes merchandise category, formal order quantity, and sales representative advice order quantity.

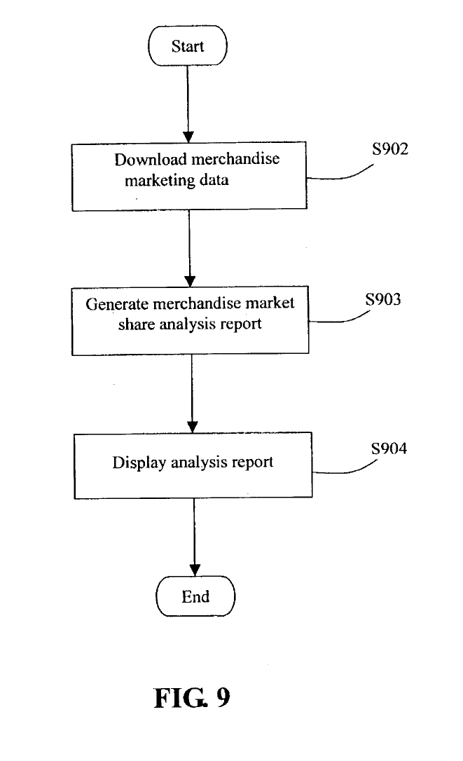

FIG. 9 is a flowchart of details of step S604 of FIG. 6, namely generating and displaying a merchandise market share analysis report. Firstly, in step S902, the mobile terminal 109 downloads merchandise marketing data. In step S903, the mobile terminal 109 processes the data, and generates a merchandise market share analysis report. Finally, in step S904, the mobile terminal 109 displays the merchandise market share analysis report in picture form as a reference for the sales representative to review.

Although only preferred embodiments of the present invention have been described in detail above, those skilled in the art will readily appreciate that many modifications to the preferred embodiments are possible without materially departing from the novel teachings and advantages of the present invention. Accordingly, all such modifications are deemed to be covered by the following claims and allowable equivalents of the claims.

What is claimed is:

1. A system for generating sales reports using a mobile terminal, the system comprising:
a database server;
a mobile commerce server linked with the database server for generating business schedules; and
at least one mobile terminal linked with the mobile commerce server for assisting execution of commercial activities in accordance with a business visit schedule downloaded from the mobile commerce server; wherein:
the at least one mobile terminal comprises:
a business schedule storing module for storing the downloaded business schedules and assisting arrangement of business visits, and
a data analyzing module for processing data and generating sales reports; and
the mobile commerce server comprises an application processing module for generating business schedules in accordance with data stored in the database server, and for updating data stored in the database server in accordance with data sent from the at least one mobile terminal.

2. The system for generating sales reports using a mobile terminal as claimed in claim 1, wherein the data analyzing module further comprises a merchandise distribution analyzing module for processing distribution data, and a market share analyzing module for processing market sales data.

3. The system for generating sales reports using a mobile terminal as claimed in claim 1, wherein the at least one mobile terminal further comprises a bar code scanning module for identifying bar codes of clients.

4. A method for generating sales reports using a mobile terminal, the method comprising the steps of:
(a) displaying information on commercial promotion activities;
(b) processing merchandise distribution data, and generating a merchandise distribution analysis report; and
(c) compiling merchandise sales data, and generating a market share analysis report.

5. The method for generating sales reports using a mobile terminal as claimed in claim 4, further comprising the step of:
scanning and comparing verified merchandise information, key merchandise information and merchandise average weekly sales records.

6. The method for generating sales reports using a mobile terminal as claimed in claim 4, wherein step (b) of processing merchandise distribution data and generating a merchandise distribution analysis report further comprises the steps of:
(b1) reading data on a corresponding previous sales representative advice orders and on a current formal order;
(b2) reading current verified merchandise data;
(b3) compiling and analyzing all collected data; and
(b4) generating the merchandise distribution analysis report.

7. The method for generating sales reports using a mobile terminal as claimed in claim 6, wherein step (b) of processing merchandise distribution data and generating a merchandise distribution analysis report further comprises the step of:
(b5) displaying the merchandise distribution analysis report in picture form.

8. The method for generating sales reports using a mobile terminal as claimed in claim 4, wherein step (c) of compiling merchandise sales data and generating a market share analysis report further comprises the steps of:
(c1) downloading merchandise marketing data;
(c2) analyzing merchandise market share; and
(c3) generating the merchandise market share analysis report.

9. The method for generating sales reports using a mobile terminal as claimed in claim 8, wherein step (c) of compiling merchandise sales data and generating a market share analysis report further comprises the step of:
(c4) displaying the merchandise market share analysis report in picture form.

10. A method of doing business for a sales representative using a mobile terminal during visiting a client, comprising steps of:
obtaining information on commercial promotion activities including current and future ones;
displaying said information to the client if related;
retrieving data on a previous sales representative advice order and those on a corresponding previous actual order set by the client;
reading data on a current merchandise date on a site of said client;
comparing said three data and analyzing a result to persuade the client of taking a future advise order of the sales representative; and
presenting said future advise order to the client.
